(19) United States
(12) Patent Application Publication
(10) Pub. No.: US 2008/0311448 A1
(43) Pub. Date: Dec. 18, 2008

(54) High Temperature Polymer Electrolyte Membrane Fuel Cells

(75) Inventors: Dominic Francis Gervasio, Fountain Hills, CA (US); James Kinder, Bellevue, WA (US)

Correspondence Address: FISH & RICHARDSON, PC, P.O. BOX 1022, MINNEAPOLIS, MN, 55440-1022, US

(73) Assignee: Arizona Board of Regents for and on behalf of Arizona State University, Scottsdale, AZ (US)

(21) Appl. No.: 12/110,255

(22) Filed: Apr. 25, 2008

Related U.S. Application Data
(60) Provisional application No. 60/914,685, filed on Apr. 27, 2007.

(51) Int. Cl. H01M 8/18; H01M 8/10; H01M 8/04

(52) U.S. Cl. 429/19; 429/30; 429/24

(57) ABSTRACT

High temperature polymer electrolyte membrane fuel cells and techniques related thereto that involve alternative materials. For example, in one aspect, a device includes a high temperature polymer electrolyte membrane fuel cell comprising one or more metal anodes or cathodes.

### CROSS-REFERENCE TO RELATED APPLICATIONS

This application claims priority of U.S. Provisional Application Ser. No. 60/914,685, filed on Apr. 27, 2007, the contents of which are incorporated herein by reference.

### BACKGROUND

This disclosure relates to high temperature polymer electrolyte membrane fuel cells.

A fuel cell is a galvanic electrochemical cell that oxidizes a fuel at an anode and reduces an oxidant (typically, oxygen from air) at a cathode to generate electricity. The fuel and the oxidant are different chemical species and therefore the electrodes have different chemical potentials. Accordingly, a potential difference (i.e., the electromotive force) can be generated between an anode and a cathode even when the anode and the cathode are made from the same material. For example, anodes and cathodes can include a platinum catalyst that is neither consumed nor produced by the oxidation or reduction reactions but instead remains largely intact. If the electrodes remain intact, the electromotive force for the generation of electricity can, in principal, continue indefinitely provided that the fuel and oxidant are supplied to the cell.

In general, the oxidation and reduction reactions will occur in the presence of an electrolyte. Proton conducting electrolytes, such a polymer electrolyte membranes (also known as “proton-exchange membranes”) can act as the electrolyte in a fuel cell. Polymer electrolyte membranes in fuel cells are preferentially permeable to cations such as the protons generated by the oxidation of the fuel. The reduced permeability to the electrons generated by the oxidation of the fuel can be used to direct energized electrons from the anode through an external load and then to the cathode, where electrons and protons combine with oxygen to form water. The directed current flow of energized electrons through the external load can be used to do work.

One source of protons is from the oxidation of hydrogen gas from reformed hydrocarbons. Hydrogen gas from reformed hydrocarbons is less expensive than hydrogen gas from water electrolysis but generally includes higher concentrations of contaminants such as carbon monoxide. At low temperatures (e.g., between room temperature and 140° C.), even trace amounts of carbon monoxide can poison a platinum catalyst and impair or even halt the generation of electricity. At higher temperatures (e.g., above 140° C., such as between 160° C. and 200° C.), platinum catalysts can tolerate higher levels of carbon monoxide and other contaminants in gaseous hydrogen fuel. For example, a platinum catalyst can tolerate up to 2% CO without crippling performance loss.

In addition to facilitating the use of reformed hydrocarbon feedstocks, high temperature polymer electrolyte membrane fuel cells have other advantages. For example, high temperature polymer electrolyte membrane fuel cells have been shown to operate for relatively long periods (e.g., in excess of 10,000 hours) and with a relatively low amount of performance degradation over time (e.g., less than about 0.0045 mV/h). Many high temperature polymer electrolyte membrane fuel cells also have relatively favorable design characteristics, including relatively high shock and vibration tolerance, gas phase reactants and products (which provides simplified one-phase fluid handling and relatively simple water management issues), fewer thermal control issues (e.g., smaller radiators and simplified reformer integration into fuel cells), and increased catalytic activity associated with higher temperatures.

Because high temperature polymer electrolyte membrane fuel cells operate at relatively high temperatures, there are certain fundamental limitations on the materials that are used in high temperature polymer electrolyte membrane fuel cells. For example, commercially available NAFION, which is a common polymer electrolyte membrane in low temperature applications, is generally only conductive below 120° C. and hence not used in high temperature polymer electrolyte membrane fuel cells. Instead, polybenzimidazole fiber that is loaded with phosphoric or other acid can be formed into a polymer electrolyte membrane and is used in high temperature polymer electrolyte membrane fuel cells. The acidic, high temperature environment created by this use is relatively highly corrosive and places other limitations on material properties of other fuel cell components, such as the bipolar plates. Bipolar plates collect the current while funneling chemicals to and products from the anode and cathode.

Bipolar plates in high temperature polymer electrolyte membrane fuel cells can be made from conducting carbon, such as POCO graphite plates. Graphite is a conducting carbon that oxidizes slowly. The conducting surface of graphite plates thus remains suitable even for high temperature polymer electrolyte membrane fuel cells for relatively long periods. However, graphite is relatively bulky and difficult to fabricate into the forms convenient for use as bipolar plates.

Nitrided metals, such as stainless steel, are candidate materials for bipolar plates in room temperature fuel cells.

### SUMMARY

The present inventors have recognized that conducting carbon bipolar plates are heavy, difficult to machine, and relatively brittle. Experimental investigations have shown that certain metals may be suitable replacements for conducting carbon in the bipolar plates of high temperature polymer electrolyte membrane fuel cells. Also, the inventors have recognized that certain polymeric materials may be suitable for making endplates of high temperature polymer electrolyte membrane fuel cell stacks. These materials can thus lead to fuel cells stacks with higher specific and volumetric power densities.

Accordingly, the inventors have developed high temperature polymer electrolyte membrane fuel cells and techniques related thereto that involve alternative materials.

The details of one or more implementations are set forth in the accompanying drawings and the description below. Other features and advantages will be apparent from the description and drawings, and from the claims.

### DESCRIPTION OF DRAWINGS

FIG. 1 is a schematic representation of a high temperature polymer electrolyte membrane fuel cell.

FIGS. 2-4 are graphs that illustrate aspects of the corrosion resistance provided by HASTELLOYS.

FIG. 5 shows another implementation of anodes and/or cathodes in the high temperature polymer electrolyte membrane fuel cell of FIG. 1.

FIG. 6 is a schematic representation of a high temperature polymer electrolyte membrane fuel cell stack.

FIG. 7 illustrates a system for generating electricity that includes high temperature polymer electrolyte membrane fuel cells.

FIG. 8 is a graph that illustrates the operational characteristics of one implementation of the system FIG. 7.

FIG. 9 is a graph that illustrates the operational characteristics of a PEMEAS MEA housed by Hastelloy bipolar plates before and after soaking the plates in phosphoric acid at 150° C. for 12 hours.

Like reference symbols in the various drawings indicate like elements.

### DETAILED DESCRIPTION

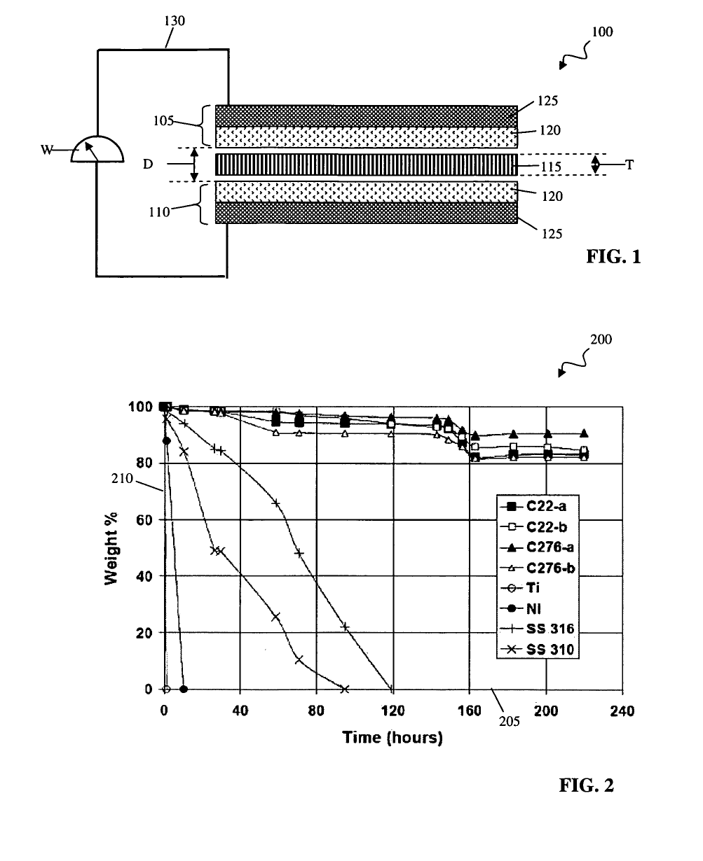

FIG. 1 is a schematic representation of one implementation of a high temperature polymer electrolyte membrane fuel cell 100. Fuel cell 100 includes an anode 105 and a cathode 110 that are separated by a proton conducting electrolyte 115. Proton conducting electrolyte 115 preferentially conducts protons from anode 105 to cathode 110. For example, proton conducting electrolyte 115 can be a polymer electrolyte membrane such as polybenzimidazole fiber that is loaded with phosphoric or other acid.

Anode 105 and cathode 110 each include a catalyst 120 and a conductive plate 125. Catalyst 120 can be one or more materials that catalyze oxidation and reduction reactions that occur at anode 105 and cathode 110. In some implementations, catalyst 120 can be identical in both anode 105 and cathode 110. In other implementations, catalyst 120 in anode 105 can differ in composition and/or treatment from catalyst 120 in cathode 110. Catalyst 120 in can be porous platinum catalysts that are poisoned by carbon monoxide at low temperatures.

Conductive plate 125 can be self-supporting solid member that defines an outer boundary of the region where reactions occur in fuel cell 100. Each conductive plate 125 can be in electrical contact with a corresponding catalyst 120 so that electrons released from fuel in anode 105 are provided a conductive path 130 to cathode 110 for the reduction of oxidant. The electrons flowing along path 130 can be used to perform work W. Fuel and oxidant can be supplied to cell 100 over any of a number of different flow paths. For example, anode 105 and cathode 110 can be separated by a distance D that is larger than a thickness T of proton conducting electrolyte 115. Fuel and oxidant can be supplied to cell 100 through the resulting gap. As another example, one or more of conductive plates 125 and catalysts 120 can include channels (not shown) for the supply of fuel and oxidant to cell 100.

Please note that although conductive plates 125 can be separated from proton conducting electrolyte 115 by catalysts 120 and/or the gap discussed above, in practical terms, conductive plates 125 are likely to be exposed to proton conducting electrolyte 115 during operation. For example, the movement of fuel cell 100, the generation of gaseous species, the use of porous catalysts 120, and/or defects and other vagaries in the construction of fuel cell 100 will result in contact between conductive plates 125 and fluids in proton conducting electrolyte 115. Such fluids can include acids that load a polybenzimidazole proton conducting electrolyte 115.

High temperature polymer electrolyte membrane fuel cell 100 can be designed to operate at temperatures in excess of 140° C., such as between 160° C. and 200° C. or between 160° C. and 190° C. This design can be implemented using thermal management systems, as discussed further below. Despite these relatively high operational temperatures and the corrosive environment created by acidic proton conducting electrolytes 115, one or more conductive plates 125 can be made from a metal. For example, conductive plates 125 can include high nickel-content steel alloys such as HASTELLOYS (Haynes International, Inc., Kokomo, Ind., U.S.A.). For example, conductive plates 125 can be made from HASTELLOY C276, HASTELLOY C22, HASTELLOY C2000, and combinations thereof. As another example, conductive plates 125 can be made from low chromium HASTELLOYS, such as HASTELLOY B3 and HASTELLOY C242.

The composition of HASTELLOY C276, HASTELLOY C22, HASTELLOY C2000 is presented in Table 1. The composition of HASTELLOY B3 is presented in Table 2 and HASTELLOY C242 is presented in Table 3.

When conductive plates 125 are made from metals, they can be made relatively thin, for example, about 0.1 mm (4 mil) thick. This relative thinness decreases the weight of conductive plates 125 and hence the volume and weight of fuel cell 100. Such decreases in volume and weight are of particular importance when fuel cell 100 is to be moved, such as when fuel cell 100 is part of a vehicle.

TABLE 1

| Alloy | | | | | | | | | | | | | | |
|---|---|---|---|---|---|---|---|---|---|---|---|---|---|---|
| Designation | UNS# | C | Co | Cr | Cu | Fe | Mn | Mo | Ni | P | S | Si | V | W |
| Hastelloy(R) | N10275 | 4e−3 | 1.45 | 15.74 | n/a | 5.58 | 0.50 | 15.53 | 57.55 | 0.008 | 0.003 | 0.02 | 0.163 | 3.45 |
| C276 | | | | | | | | | | | | | | |
| Hastelloy(R) | N06022 | 4e−3 | 0.72 | 21.00 | n/a | 3.90 | 0.23 | 13.30 | 57.90 | 0.011 | 0.004 | 0.026 | 0.013 | 2.90 |
| C22 | | | | | | | | | | | | | | |
| Hastelloy(R) | N06200 | 1e−3 | 0.05 | 22.71 | 1.54 | 0.65 | 0.23 | 15.64 | 59.12 | 0.003 | 0.004 | 0.043 | n/a | n/a |
| C2000 | | | | | | | | | | | | | | |

TABLE 2

| Alloy | Ni | Mo | Cr | Fe | Co | W | Mn | Al | Ti | Si |
|---|---|---|---|---|---|---|---|---|---|---|
| B3 | 65^{b} | 28.5 | 1.5 | 1.5 | 3* | 3* | 3* | 0.5* | 0.2* | 0.1* |

^{b}Minimum
*Maximum

TABLE 3
ALLOY C242
65Ni^{a}—25Mo—8Cr—2.5Co*—2Fe*—0.8Mn*—0.8Si*—0.5Al*0.5Cu*—0.03C*—0.006B*
^{a}As Balance
*Maximum

When conductive plates 125 are made from metals, they can be fabricated using metal fabrication techniques, such as stamping. Such stamping can be used to pattern or otherwise form features in conductive plates 125. For example, channels for the supply of fuel and oxidant to cell 100 can be stamped in conductive plates 125.

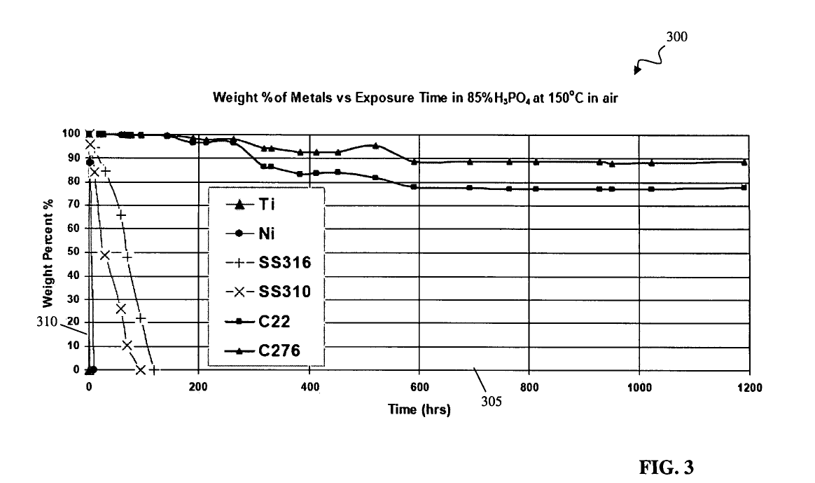

FIG. 2 is a graph 200 that illustrates one aspect of the corrosion resistance provided by HASTELLOYS. In particular, graph 200 includes an X-axis 205 and a Y-axis 210. The position of ordinates along Y-axis 210 reflects the weight-% of metal coupons that remain after exposure to 85% H₃PO₄ at 150° C. in air. The position of abscissae along X-axis 205 reflects the time after such exposure commenced. The behavior of the samples under these conditions is believed to reflect the relative stability of conductive plates 125 formed from these metals under operational conditions in high temperature polymer electrolyte membrane fuel cells.

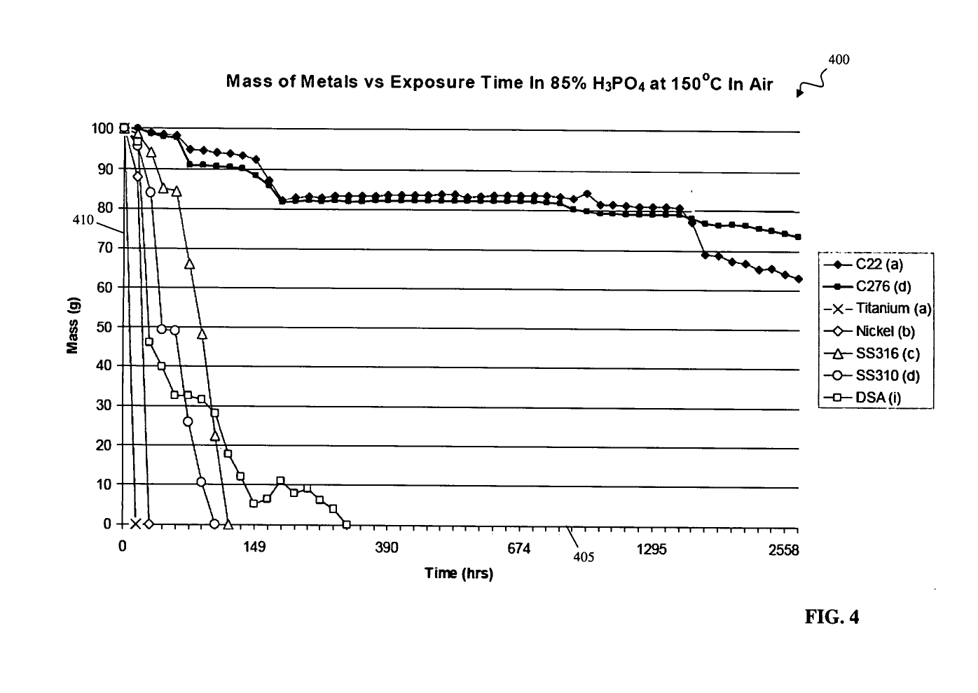

These measurement results, and the results illustrated in FIGS. 3 and 4 below, were made using HASTELLOY were obtained from Haynes International. Other metal samples were donated by GenCell (Southbury, Conn.). Weight measurements were made by weighing metal samples of approximately 1 cm×2 cm×0.1 cm in size and approximately 1 g to 2 g in weight, submerging the samples in 85% phosphoric acid at 150° C. in air, removing selected samples at known intervals, rinsing the removed samples in water and alcohol, and then drying the rinsed samples in an oven at 100° C. in air for 1 minute. The samples were then reweighed. Metal resistance was measure in plane using a DC ohmmeter with probes in the middle of the sample and separated by 1 cm along the 2 cm length of the metal strip.

As can be seen, HASTELLOY C22, HASTELLOY C2000, and two different samples of HASTELLOY C276 (i.e., “C276-a” and “C276-b”) retain over 80% of their weight after 200 hours. On the other hand, titanium, nickel, and stainless steels SS316 and SS310 lose weight much quicker. The weight retention of HASTELLOY C22, HASTELLOY C2000, and/or HASTELLOY C276 is due to the rapid passivation of HASTELLOY C22, HASTELLOY C2000, and/or HASTELLOY C276 through the formation of a passivation layer on the exposed surfaces thereof. Since the amount of weight lost from HASTELLOY C22, HASTELLOY C2000, and HASTELLOY C276 is relatively low, conductive plates 125 made therefrom can be thin and light weight.

A resistance of 0.6 Ohms was measured on 1 cm by 2 cm by 0.1 cm HASTELLOY C22 and C276 plates with probes that were 1 cm apart on long side. Such a conductivity is believed to be sufficient to allow conductive plates 125 made from HASTELLOY C22, HASTELLOY C2000, and/or HASTELLOY C276 to be in electrical contact with a corresponding catalyst 120. This conductivity remains despite the rapid repassivation of HASTELLOY C22, HASTELLOY C2000, and/or HASTELLOY C276. In particular, the passivations layers retain and electron conductivity that is similar to metals such as copper and aluminum.

FIG. 3 is a graph 300 that illustrates another aspect of the corrosion resistance provided by HASTELLOYS. In particular, graph 300 includes an X-axis 305 and a Y-axis 310. The position of ordinates along Y-axis 210 reflects the weight-% of metal coupons that remain after exposure to 85% H₃PO₄ at 150° C. in air. The position of abscissae along X-axis 205 reflects the time after such exposure commenced. The behavior of the samples under these conditions is believed to reflect the relative stability of conductive plates 125 formed from these metals under operational conditions in high temperature polymer electrolyte membrane fuel cells.

As can be seen, HASTELLOY C22 and HASTELLOY C276 retain over 70% of their weight after 1200 hours. Moreover, the rate of decrease in weight become negligible. On the other hand, titanium, nickel, and stainless steels SS316 and SS310 lose weight much quicker. The weight retention of HASTELLOY C22 and HASTELLOY C276 is due to the rapid passivation of HASTELLOY C22 and HASTELLOY C276 through the formation of a passivation layer on the exposed surfaces thereof. Since the amount of weight lost from HASTELLOY C22 and HASTELLOY C276 is relatively low, conductive plates 125 made therefrom can be thin and light weight. Since the dissolution rate of HASTELLOY C22 and HASTELLOY C276 is relatively low, conductive plates 125 made therefrom can have long operational lifespans.

FIG. 4 is a graph 400 that illustrates another aspect of the corrosion resistance provided by HASTELLOYS. In particular, graph 400 includes an X-axis 405 and a Y-axis 410. The position of ordinates along Y-axis 210 reflects the weight-% of metal coupons that remain after exposure to 85% H₃PO₄ at 150° C. in air. The position of abscissae along X-axis 205 reflects the time after such exposure commenced. The behavior of the samples under these conditions is believed to reflect the relative stability of conductive plates 125 formed from these metals under operational conditions in high temperature polymer electrolyte membrane fuel cells.

As can be seen, HASTELLOY C22 and HASTELLOY C276 retain over 60% of their weight after 2560 hours. On the other hand, titanium, nickel, stainless steels SS316 and SS310, and dimensionally stable anode (DSA), a ruthenium oxide coated titanium sheet lose weight much quicker. The weight retention of HASTELLOY C22 and HASTELLOY C276 is due to the rapid passivation of HASTELLOY C22 and HASTELLOY C276 through the formation of a passivation layer on the exposed surfaces thereof. Since the amount of weight lost from HASTELLOY C22 and HASTELLOY C276 is relatively low, conductive plates 125 made therefrom can be thin and light weight. Since the dissolution rate of HASTELLOY C22 and HASTELLOY C276 is relatively low, conductive plates 125 made therefrom can have long operational lifespans.

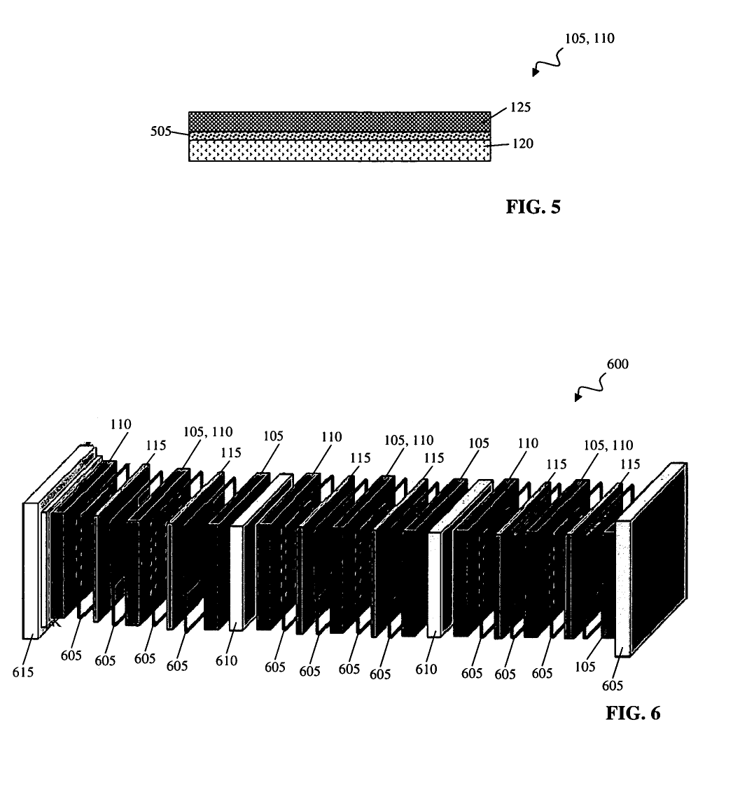

FIG. 5 shows another implementation of either of anode 105 and/or cathode 110. In addition to catalyst 120 and conductive plate 125, these implementations of electrodes 105, 110 also includes a layer 505 of corrosion resistant material between catalyst 120 and conductive plate 125.

Layer 505 can have a corrosion resistance that exceeds that of conductive plate 125, even if conductive plate 125 is formed from one or more HASTELLOY's, as discussed above. Layer 505 can be formed from a material having a low electrical sheet resistance. For example, layer 505 can be formed from a graphite or noble metal paint, ruthenium oxide, and/or sputtered, evaporated, or plated noble metals. In one implementation, layer 505 can be formed from a dispersion of semi-colloidal graphite in a thermoset binder, such as DAG EB-023 or DAG EB-030 (Acheson Colloid U.S., Port Huron, Mich. USA). In another implementation, layer 505 can be formed from gold electroplate. For example, a gold layer can be electroplated to have a thickness that is thicker than 10 nanometers, e.g., up to several microns.

Layer 505 can be so thin that it is not self-supporting. In other words, layer 505 can require support from conductive plate 125 to retain mechanical stability. For example, layer 505 can be applied as a paint, using spraying and or brushing. As another example, layer 505 can be applied using thin film deposition techniques such as spin or dip coating.

Please note that layer 505 need not be free from defects. Rather, layer 505 can include one or more defects that allow catalyst 120 and conductive plate 125 to contact.

FIG. 6 is a schematic representation of a high temperature polymer electrolyte membrane fuel cell stack 600. A fuel cell stack is a collection of fuel cells that are electrically connected in series. High temperature polymer electrolyte membrane fuel cell stack 600 includes a collection of anodes 105, proton conducting electrolytes 115, and cathodes 110 that are connected in series. Please note that a single element can act both as an anode 105 and a cathode 110 in fuel cell stack 600. In particular, as shown, fuel cell stack 600 can include one or more bipolar plates 105,110. One side of bipolar plate 105,110 can act as anode while the other side acts as a cathode in adjacent high temperature polymer electrolyte membrane fuel cells. Bipolar plates 105,110 thus form the electrical series connection between these adjacent cells.

Fuel cell stack 600 can also include sealing members 605, cooling plates 610, and end plates 615. Sealing members 605 can seal cells in stack 600 to prevent undesired mixing of fuels and oxidants. Sealing members 605 can be, e.g., thermoplastic members that are compression fit between adjacent anodes 105, proton conducting electrolytes 115, and cathodes 110.

Cooling plates 610 can be part of a thermal management system for stack 600. For example, cooling plates 610 can include a radiator element with a fluid flow path for removing heat from stack 600. In some implementations, the heat removed from stack 600 can be used to elevate the temperature of a reformer, as discussed further below. Cooling plates 610 can be electrically conductive and can electrically connect an anode 105 in one high temperature polymer electrolyte membrane fuel cell to a cathode 110 in another such cell, as shown. Cooling plates 610 can thus be part of the electrical series connection between adjacent high temperature polymer electrolyte membrane fuel cells.

End plates 615 are part of the mechanical structure of fuel cell stack 600. For example, end plates 615 can serve to isolate fuel cell stack 600 from the outside environment. End plates 615 can also be part of a mechanism for compressing fuel cell stack 600 laterally, e.g., so that compression seals can be formed by sealing members 605.

The present inventors have recognized that end plates 615 can include certain polymeric materials. For example, the inventors have recognized that end plates 615 can include polyimide composites such as AVIMID-N (DuPont de Nemours, E. I., Co., Wilmington, Del., U.S.A.). The inventors have recognized that AVIMID-N provides sufficient stiffness and mechanical strength combined with sufficient resistance to thermal oxidation and has a sufficient stability to endure long term exposure to the operational temperatures of high temperature polymer electrolyte membrane fuel cells.

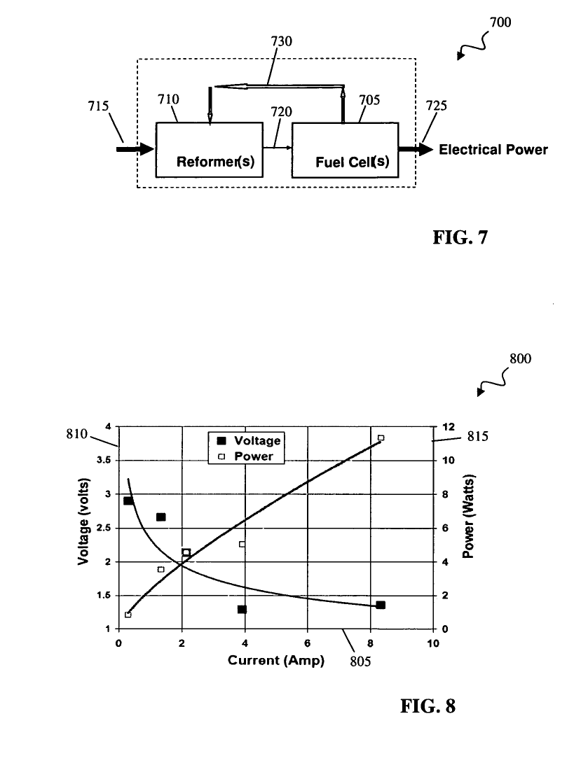

High temperature polymer electrolyte membrane fuel cells can be incorporated into a system for generating electricity either individually or as part of a fuel cell stack. FIG. 7 illustrates such a system, namely, a system 700 that includes one or more fuel cells 705 and one or more reformers 710. Fuel cells 705 can include one or more fuel cells 100 (FIG. 1). For example, fuel cells 705 can include several fuel cells 100 arranged in electrical series in a fuel cell stack 600 (FIG. 6). Reformers 710 can include one or more reformers to crack hydrocarbons and form a fuel such as hydrogen gas. For example, reformers 710 can be one or more methanol steam reformers, such as those described in U.S. Patent Publication No. 2004/0179980 to A. Pattekar and M. Kothare, the contents of which are incorporated herein by reference.

In operation, a hydrocarbon-containing feedstock 715 (such as methanol and water) can be fed into reformers 710. Reformers 710 can crack feedstock 715 to yield fuel 720 (such as hydrogen) that is fed into fuel cells 705. Please note that, given that fuel cells 705 can be high temperature polymer electrolyte membrane fuel cells, fuel 720 can include carbon monoxide and other contaminants and yet platinum catalysts in fuel cells 705 can remain operational. Fuel cells 705 can oxidize fuel 720 to generate electrical power 725 that can be used to do work. As a consequence of the reactions associated with oxidizing fuel 720, fuel cells 705 can also generate excess heat 730 that can be returned to reformers 710 for use in cracking feedstock 715. For example, heat 730 can be used to vaporize feedstock 715.

FIG. 8 is a graph 800 that illustrates the operational characteristics of one implementation of a system 700 (FIG. 7). In this implementation, a four cell, 10 watt stack that operated at 170° C. was fed air and hydrogen from a pair of methanol steam reformers that operated in parallel. The methanol reformers have been described in the article entitled “A Microreactor for Hydrogen Production in Micro-Fuel Cell Applications” by A. Pattekar and M. Kothare in the Journal of Microelectromechanical Systems, Vol. 13: 7-18 (2004), the contents of which are incorporated herein by reference. The reformers were loaded with Sud Chemie C18-7 Cu/ZnO/Al₂O₃ catalyst, heated on a hot plate to a temperature of approximately 180° C. The reformers were <0.02 liter in volume and weighed 0.05 kilogram. A liquid feedstock of 1 part methanol to 1.25 part water was fed to the reformers at 8 ml per hour (152 sccm hydrogen gas) using a precision syringe pump and a 10 ml Hamilton μL Gastight syringe. Fluid connections between the feedstock source and the reformers, and from the reformers to the fuel cell stack, were made using Teflon tubing.

As the liquid feedstock reached the reformer inlets, pressures of 3 to 15 psig start to accumulate. A condenser was used to remove liquid water and trace amounts of methanol from the reformate and the dry reformate was input into the fuel cell stack. The fuel cell stack used a polybenzimidazole proton electrolyte membrane (PEM), as described in the publication entitled “A H₂/O₂ Fuel Cell Using Acid Doped Polybenzimidazole as a Polymer Electrolyte” by J-T. Wang, et al. in Electrochimica Acta, Vol. 41, pp. 193-197 (1996), the contents of which are incorporated herein by reference. Platinum-catalyzed porous electrodes with a loading of about 1 mg-Pt/cm2 were used to make membrane electrode assemblies. Such assemblies have been demonstrated to have long term operational lifespans (>10,000 hours) with a performance degradation rate of only ˜0.0045 mV/h. The fuel cell stack included four phosphoric acid loaded PBI MEAs (Area per MEA=25 cm2; Total area per 4-cell stack=100 cm2) (available from PEMEAS, Murray Hill, N.J.) in an commercial graphite four cell stack housing fitted with a resistance heater (Electrochem Inc, Woburn Mass.). The resistance heater was controlled by a thermocouple fitted to feedback electrical controller (Omega).

The internal resistance of the four cell in series stack at open circuit conditions at 150° C. was 0.5 Ohm per 25 cm², and was obtained from the real and imaginary plot of the stack impedance as the high frequency intercept of impedance on the real axis using a Solartron 1286 electrochemical interface (potentiostat) coupled to a Solartron 1250 frequency response analyzer (FRA). The measurement parameters included a potentiostatic amplitude of 10 mV and a frequency of 0.1 to 50,000 Hz.

The performance of the system as a power source was measured by connecting resistors between the anode and cathode and measuring the voltage across the resistors. The cell current was measured using an ammeter connected in series with the load.

Graph 800 includes an X-axis 805 and a pair of Y-axes 810, 815. The position of ordinates along Y-axis 810 reflects the voltage in volts that was output from this system. The position of ordinates along Y-axis 815 reflects the power in watts that was output from this system. The position of abscissae along X-axis 805 reflects the current in amps that that was output from this system.

In some implementations, metal conductive plates 125 can be preconditioned for use in a high temperature polymer electrolyte membrane fuel cell 100. For example, high nickel-content steel alloys such as HASTELLOYS can be preconditioned to improve stability under high temperature polymer electrolyte membrane fuel cell conditions. In one implementation, HASTELLOYS such as HASTELLOY C22 can be preconditioned by soaking in phosphoric acid at 150° C. overnight. After removal, the surface can be abraded (e.g., using 600 SiC sandpaper) and the stability of the metal conductive plate in a high temperature polymer electrolyte membrane fuel cell can be improved.

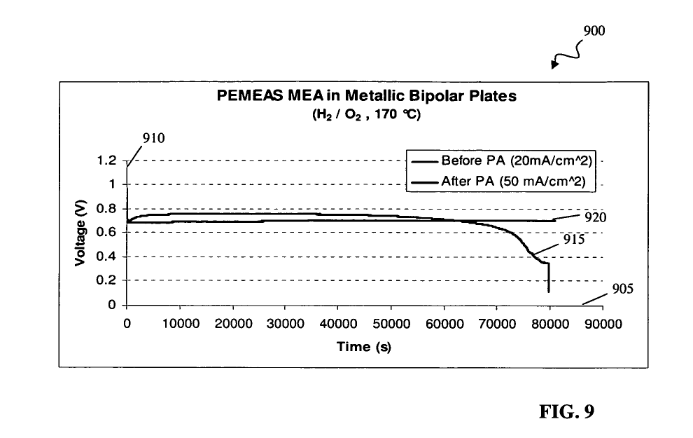

FIG. 9 is a graph 900 that illustrates the operational characteristics of an implementation of a system 700 (FIG. 7) in which metal conductive plates 125 can be preconditioned. In this implementation, the fuel cell operates above 170° C. using a PEMEAS membrane electrode assembly having a commercial phosphoric acid loaded polybenzimidazole membrane sandwiched between platinum catalyzed porous gas-fed electrodes (i.e., oxygen was fed to the cathode and hydrogen was fed to the anode).

Graph 900 includes an X-axis 905 and a Y-axis 910. The position of ordinates along Y-axis 910 reflects the voltage that the fuel cell produced. The position of abscissae along X-axis 905 reflects the time that the fuel cell was operated. A pair of traces 915, 920 are plotted on graph 900. Trace 915 shows the voltage generated with HASTELLOY C22 plates that were not preconditioned at a current density of 20 mA/cm². Trace 9205 shows the voltage generated at a current density of 50 mA/cm² using HASTELLOY C22 plates that were preconditioned by soaking in phosphoric acid at 150° C. overnight and abraded using 600 SiC sandpaper. As can be seen, HASTELLOY C22 plates without preconditioning are stable for about 60,000 seconds and fail after about 80,000 seconds. Preconditioned HASTELLOY C22 plates are stable beyond the period illustrated in the graph.

Although the physical mechanism underlying the effectiveness of such preconditioning is still being investigated, it is suspected that preconditioning depletes one or more impurities from the plates 125. For example, it is suspected that chromium impurities may be depleted.

A number of implementations have been described. Nevertheless, it will be understood that various modifications may be made. For example, proton conducting electrolyte 115 and catalysts 120 can be purchased as a unit, such as the polymer electrolyte membrane electrode assemblies available from PEMEAS (Murray Hill, N.J., U.S.A.). In cases such as these, there is no need for a seal between proton conducting electrolyte 115 and catalysts 120. Instead a seal can be positioned between catalysts 120 and a conductive plate 125 to prevent undesired mixing of fuels and oxidants. Accordingly, other implementations are within the scope of the following claims.

What is claimed is:

1. A device comprising:
a high temperature polymer electrolyte membrane fuel cell comprising one or more metal anodes or cathodes that define an outer boundary of a region where reactions occur in the high temperature polymer electrolyte membrane fuel cell.

2. The device of claim 1, wherein:
the device further comprises a hydrocarbon reformer to generate a fuel to be oxidized by the high temperature polymer electrolyte membrane fuel cell, wherein the fuel includes a carbon monoxide contaminant; and
the fuel cell further comprises a platinum catalyst.

3. The device of claim 3, wherein the fuel comprises hydrogen.

4. The device of claim 1, wherein the metal anodes or cathodes comprise one or more bipolar electrodes that define one or more regions where reactions occur in two or more adjacent high temperature polymer electrolyte membrane fuel cells.

5. The device of claim 1, wherein the metal anodes or cathodes comprise a high nickel-content steel alloy.

6. The device of claim 5, wherein the high nickel-content steel alloy comprises a preconditioned high nickel-content steel alloy.

7. The device of claim 6, wherein the preconditioned high nickel-content steel alloy is depleted of one or more impurities.

8. The device of claim 5, wherein the high nickel-content steel alloy comprises a HASTELLOY.

9. The device of claim 4, wherein the high nickel-content steel alloy comprises one or more of HASTELLOY C276, HASTELLOY C22, HASTELLOY C2000, HASTELLOY B3, and HASTELLOY 242.

10. The device of claim 1, wherein the high temperature polymer electrolyte membrane fuel cell comprises a thermal management system to provide an operating temperature above 140° C.

11. The device of claim 11, wherein the thermal management system is to provide an operating temperature between 160° C. and 200° C.

12. The device of claim 1, wherein the metal electrodes further comprise a layer of corrosion resistant material on one or more surfaces of the metal electrodes.

13. The device of claim 12, wherein the layer of corrosion resistant material comprises a dispersion of a semi-colloidal conductor in a polymeric binder.

14. The device of claim 13, wherein the dispersion comprises one or more of DAG EB-023 and DAG EB-030.

15. The device of claim 1, wherein the fuel cell further comprises a porous platinum catalyst to catalyze at least one of an oxidation reaction and a reduction reaction.

16. The device of claim 1, wherein the high temperature polymer electrolyte membrane fuel cell further comprises a polymeric endplate to mechanically structure the high temperature polymer electrolyte membrane fuel cell.

17. The device of claim 16, wherein the polymeric endplate comprises a polyimide composite.

18. The device of claim 17, wherein the polyimide composite comprises AVIMID-N.

19. The device of claim 1, wherein the high temperature polymer electrolyte membrane fuel cell further comprises a proton conducting electrolyte that is loaded with an acid.

20. The device of claim 19, wherein the proton conducting electrolyte comprises polybenzimidazole loaded with phosphoric acid.

21. A device comprising:
a hydrocarbon reformer to generate a gaseous hydrogen fuel, wherein the gaseous hydrogen includes a carbon monoxide contaminant;
a fuel cell stack comprising
a thermal management system to provide an operating temperature above 140° C., and
a collection of high temperature polymer electrolyte membrane fuel cells including a platinum catalyst to catalyze at least one of an oxidation reaction and a reduction reaction and one or more bipolar metal electrodes to define boundaries of adjacent fuel cells and act as a cathode in one of the adjacent fuel cells and as an anode in the other of the adjacent fuel cells; and
a fluid flow path to conduct the oxidizable fuel from the hydrocarbon reformer to the fuel cell stack.

22. The device of claim 21, wherein the bipolar metal electrodes comprise one or more of HASTELLOY C276, HASTELLOY C22, HASTELLOY C2000, HASTELLOY B3, and HASTELLOY 242.

23. The device of claim 21, wherein the bipolar metal electrodes comprise a layer of corrosion resistant material.

24. The device of claim 23, wherein the layer of corrosion resistant material comprises a dispersion of a semi-colloidal carbon in a polymeric binder.

25. The device of claim 21, wherein the bipolar metal electrodes comprise a stamped sheet.

26. The device of claim 21, wherein the high temperature polymer electrolyte membrane fuel cells further comprise a polybenzimidazole proton conducting electrolyte that is loaded with a strong acid.

27. A device comprising:
a high temperature polymer electrolyte membrane fuel cell comprising one or more stamped metal anodes or cathodes.

28. The device of claim 27, wherein the stamped metal anodes or cathodes define one or more fluid flow channels for the supply of fuel or oxidant to the fuel cell.

29. The device of claim 27, wherein the stamped metal anodes or cathodes comprise a high nickel-content steel alloy.

30. The device of claim 29, wherein the high nickel-content steel alloy comprises one or more of HASTELLOY C276, HASTELLOY C22, HASTELLOY C2000, HASTELLOY B3, and HASTELLOY 242.

31. A device comprising:
a high temperature polymer electrolyte membrane fuel cell comprising one or more metal plates in communication with a proton conducting electrolyte that is loaded with a strong acid.

32. A high temperature polymer electrolyte membrane fuel cell, the improvement comprising one or more metal electrodes.

33. A method comprising:
generating electricity using a high temperature polymer electrolyte membrane fuel cell that includes a metal plate in contact with a proton conducting electrolyte that is loaded with a strong acid.

34. The method of claim 33, further comprising preconditioning the metal plate.
